(19) United States
(12) Patent Application Publication
(10) Pub. No.: US 2001/0049679 A1
(43) Pub. Date: Dec. 6, 2001

(54) System and method for providing computer network search services

(75) Inventor: Robert B. Yonaitis, Concord, NH (US)

Correspondence Address: BOURQUE & ASSOCIATES, P.A., 835 HANOVER STREET, SUITE 303, MANCHESTER, NH, 03104, US

(73) Assignee: Hiawatha Island Software Co., Inc.

(21) Appl. No.: 09/803,068

(22) Filed: Mar. 9, 2001

Related U.S. Application Data
(60) Provisional application No. 60/189,598, filed on Mar. 15, 2000.

(51) Int. Cl. G06F 17/30; G06F 15/16

(52) U.S. Cl. 707/4; 707/5; 345/769; 709/203; 707/10

(57) ABSTRACT

A system and method for providing computer network search services. The system includes a search interface builder, which provides a “wizard”-based interface and set of tools that allow a user to build search interfaces. The system also includes a token implementer, which cooperates with a token parser and one or more index maps to designate catalog fields according to a language-independent naming schema. A resource classifier is also provided by the system, which provides the ability to perform resource classification “on-the-fly”. A relevancy processor, which allows searchers and administrators to control the relevancy of a document discovered during a search depending on the source of the particular document, is also included in the system.

### RELATED APPLICATIONS

This application claims the benefit of U.S. Provisional Patent Application Ser. No. 60/189,598 filed Mar. 15, 2000, fully incorporated herein by reference.

### FIELD OF THE INVENTION

The present invention relates to a system and method of searching a computer network for desired information. More particularly, the invention concerns a system and method that classifies a search on the fly and does not rely on the use of classified catalogs of information in which to search for information.

### BACKGROUND OF THE INVENTION

The use of computer networks and in particular, large scale networks, such as the Internet, has dramatically changed the way people access information. In fact, with a computer connected to the Internet over a telephone line, a person can have access to countless sources of information, including complete library collections as well as marketing and product information. However, the vast amount of information that is available using such large scale computer networks, such as the Internet World-Wide-Web has created problems that are currently insurmountable using currently available technology.

An example of a specific problem involves searching for information on the Internet. Currently, Internet searching relies heavily on catalogs that are provided by a variety of search service providers, such as Yahoo, Alta Vista, Excite, Netscape and others, which all provide publicly accessible search engines via the Internet World-Wide-Web. The search services provided by these companies typically use a catalog of information that is built by the service provider in response to the receipt of a collection of documents that it receives and indexes. The collection of documents are classified according to a set of rules developed by the search service provider and are then cataloged according to the classification schema. After the documents are classified and cataloged, the service provider then prepares a user query interface that allows an information seeker to search the catalog according to the schema. The user interface is then provided to information seekers over a computer network, such as the Internet or an intranet portal.

However, a significant drawback of this method is that it requires a large amount of computer programming expertise to code a search catalog interface, which means that the average user, or document manager cannot set up a search catalog without assistance. Another problem is the amount of time that is required to build a classified search catalog.

The classified catalog provides a significant problem because current technology forces a classified catalog to be rebuilt every time a new resource is added to the catalog or, alternatively, in batch rebuilds as hundreds of resources are added to the catalog. The later is the more common scenario. However, since the commonly available classified catalogs contain so much information, it can take on the order of magnitude of days to rebuild a classified catalog. Therefore it is quite common that a classified catalog is never complete or never represents all of the information available!

In addition, different servers have diverse meanings/mappings of fielded elements. This complicates the search process and makes it a nearly an impossible task for classified catalogs interoperate with other catalogs. Thus, the sharing or collaboration of information is greatly impeded. This prevents web surfers or research specialists from being able to find all of the available resources on a topic, which generally leads to less then comprehensive search results.

On the other hand, if one were to chose not to apply the logic of fielded searching, a search would result in the return of a haystack of results when the searcher is desires only a needle that is hidden in the haystack. Simply put, while full text search is important it produces less than desirable results.

Accordingly, what is needed is a system and method of computer network searching that eliminates the need for complex search interfaces that require a high skill level to prepare and manipulate. Also desirable is a system and method of facilitating searching for information on a computer network that eliminates the need for currently available classification methods, which are slow and cumbersome to use and routinely provided incomplete results. Furthermore, a language-independent system would be desirable to provide interoperability of the search system to a wide variety of information catalogs.

Finally, a system and method that provides fielded searching and search result relevancy analyses for blended searches of classified and non-classified catalogs would be especially desirable.

### SUMMARY OF THE INVENTION

The present invention provides such a system and method for providing computer network search services. The system facilitates the search for cataloged information over a computer network and includes four main components. The first component is a search interface builder, which provides a “wizard”-based interface and set of tools that allow a user to build search interfaces. The search interface builder provides a simple “drag-n-drop” interface that allows for access to a plurality of catalog servers with little or no programming knowledge or experience. The second component is a token implementer, which cooperates with a token parser and one or more index maps to designate catalog fields according to a language-independent naming schema. The third main component is a resource classifier, which provides the ability to perform resource classification “on-the-fly”. The fourth and final major component of the present invention is a relevancy processor, which allows searchers and administrators to control the relevancy of a document discovered during a search depending on the source of the particular document.

### DESCRIPTION OF THE DRAWINGS

These and other features of the present invention will be better understood in reading the following description of the invention taken together with the drawings, wherein:

FIG. 1 is a block diagram of the components of a system for providing computer network search services according to the present invention;

FIG. 2 is functional diagram showing how the client side components of the present search system access server side maps and automatically translate a search from an initial resource meaning to a plurality of different resource meanings; and

FIG. 3 provides a functional diagram of how the system and method of the present invention allows blended searching of fielded and non-fielded catalogs using on-the-fly classification.

### DETAILED DESCRIPTION OF THE INVENTION

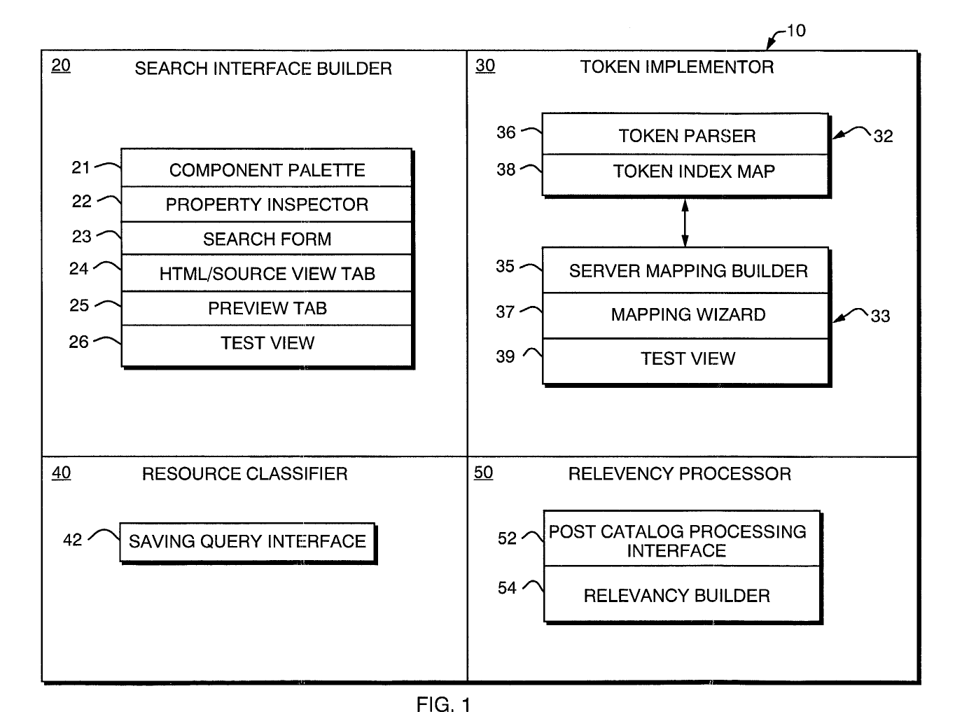

Turning now to the figures and, in particular, FIG. 1 a system 10 for providing computer network search services is provided. The system includes four main functional components that cooperate with each other to facilitate the searching of cataloged information in a language-independent, fully interoperable manner.

Search Interface Builder

The first component of the computer network search system 10 of the present invention is a search interface builder 20. The search interface builder 20 provides a “Wizard”-based user interface including a set of tools which allows a user to build one or more search interface by utilizing a simple “drag-and-drop” interface. Thus, the search interface builder 20 allows access to catalog servers by users with little or no computer programming knowledge. The search interface builder will work on Windows 32 Platforms as well as any other platform that supports Java 2 Interfaces.

The search interface builder also provides access to the other components of the search system that will be discussed in further detail below. In addition, the search interface builder links to a plurality of parent search catalog infrastructures, such as, Microsoft™, Alta Vista™, and numerous others. The search interface builder 20 also provides wrappers for additional system components as well as other, cooperating components, including: HTML, XHTML, XML, ASP, and server side code referred to as a CGI Interface. When a component is dropped onto a new search page, simply double clicking on the component on the page and completing a properties page, which is presented, will set their specific properties.

The search interface builder 20 is made of several main parts that allow for development of search pages. The first part is a component palette 21, which provides access to additional system components as well as to third party components and which provides access in the development of a new search form 23, which will be discussed below.

A second part of the search interface builder 20 is a property inspector 22. The property inspector 22 provides a detailed technical view of the system components and an overall form for users. A search form 23 is another part of the search interface builder. The search form 23 provides a visual representation of a search strategy for design time viewing.

The search interface builder also includes an HTML/Source View Tab 24, which allows advanced programmers to access the source code that makes the actual HTML pages. A preview tab 25 is also provided, which allows a system user to view a page of information in a format that will be representative of how a search system user will view the page of information using a browser. The search interface builder also includes a test view 26, which provides a connection to the search/catalog serve The test view 26 also allows for testing of a search interface that is being developed.

Token Implementer

The second component of the computer network search system 10 is a token implementer 30. The token implementer 30 provides a client token architecture 32 and a server token architecture 33. Tokens allow us to provide interoperability in search or catalog servers. Tokens are currently embedded into HTML, XML and XHTML documents.

Client Token Architecture

The client token architecture 32 of the token implementer 30 includes a token parser 36 in order to identify popular document types, such as differing types of web pages.

For example, tokens are embedded into HTML or other types of web documents as metadata, which is a special type of fielded data that identifies document properties. The document structure is as follows:

Meta name and Meta value e.g. HTML

<meta name=“Title” content=“Red”>.

A token index map 38 is also provided to map a language-dependent token name to a language-independent, numeric, alpha-numeric, character-based or other generic token identifier. The language-independent, generic token allows for an additional qualifier to an additional source that can map the name to a central or server name. For example, the following token

<meta name=“Title” content=“red” token=“4”>

provides a virtual map to a specified indexing map. In one preferred embodiment, the token provides a map to the Bib-1 (Bibliographic 1)indexing map, which is an internationally accepted indexing map. This allows for language independence in several ways. A first is language independence based on different languages—e.g. English vs. French. The other is term based e.g.- topic vs. subject.

For example, the Token “4” represents title, or the title of a resource. We can then apply this to our local schema to provide meaning to searchers regardless of language. A searcher may be located in a French speaking country or an English speaking country and may need to search a resource that is not in his or her native language. However, a searcher will typically search or think in his or her native language. In searching for a document name or title a searcher may formulate a search query tailored to find all documents where “titre” contains “Justice”. However, since “titre” is the French translation of the English word “title”, such a query would not necessarily find English language documents having a “title” that contains “Justice” since the “title” field would not be searched.

On the other hand, when tokens are implemented, the following steps would enable a search for documents where the “title” or “titre” field contains “Justice”. The first step in a token-implemented search requires a client side mapping where a client finds the “titre” field in a token map and translates it to a numeric, alpha-numeric or character-based token, e.g. Token=“4”. Then, the search string is modified to coincide with the server that will be searched. For example, the search query would be modified to select all documents where Token=“4” contains “Justice”.

Next, the modified search query is delivered to the server being searched. Finally, the server would return the results to the searcher.

The following examples expand and demonstrate the logic that is followed by the token interfaces and how tokens are treated when hitting an external server. Using the example query mentioned above, a searcher may easily search a server in the United States from a client in Canada, which is French-speaking. If we were to perform the search without the use of tokens we would receive very bad results.

Select all documents where titre contains “Justice” Well, in English, “Titre” is actually “Title”, the field would not be found or we would need to code an English and French Search page and all searchers would have to perform the searches in the native language of the server. However, this would only be feasible if the searcher knows the Language of the server.

The other problem involves searching in the same language in catalogs that may use different names for various fields. For example, a search catalog may have a totally different name for title, such as “subject”, “topic”, “resource-title” or the like. If a query designed to select all documents where “title” contains “Justice” were submitted to such a server, the search would not work because there is no field in the catalog called title. Thus, the complexity and problems of searching such a catalog have just increased dramatically.

On the other hand if a local map existed that had a Resource-Title field mapped to “4” then the translated query string would work without requiring any type of additional coding. In other words, the same query would be translated to search for all documents where Token=“4” contains “Justice”.

The use of the token component architecture allows for global information interchange and exchange as never before available. Token implementation provides easy language independent queries.

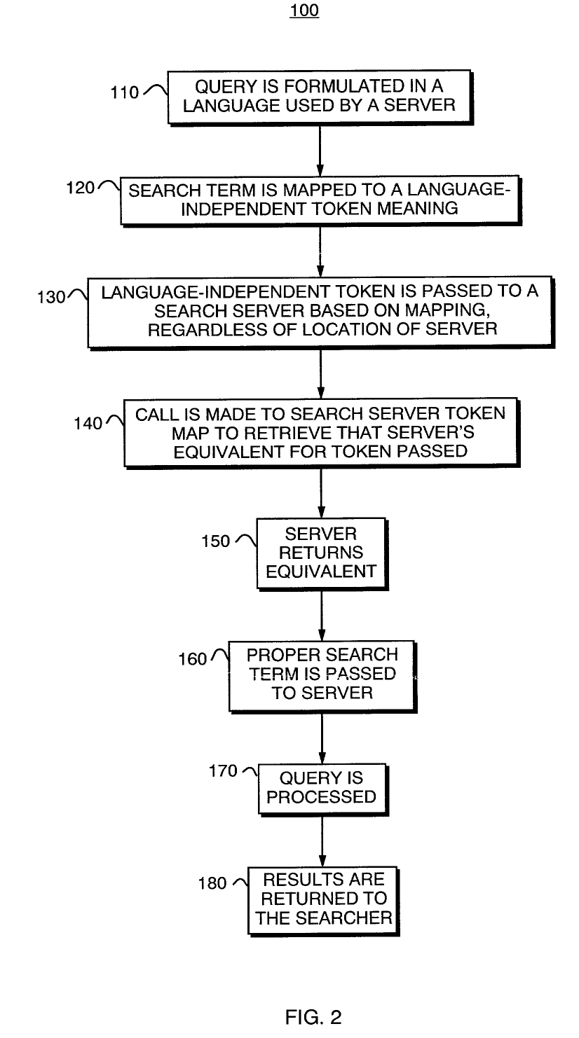

FIG. 2 provides one example of how a method 100 by which the client side components of the present search system access server side maps and automatically translate a search from an initial resource meaning to a plurality of different resource meanings. First, in step 110, a searcher formulates a query from a server in the language used by the searcher and his or her server. Then, in step 120, the search term is translated at the searcher's server using a server storage map to provide a translated, language-independent token-driven query. In step 130, the translated query is then passed to a search server based on the mapping regardless of the location of the search server.

The method continues in step 140 when a call is made to a search server token map to retrieve the server's equivalent of the passed token. The server then retrieves the equivalent token, step 150, which it passes to the search server in step 160. The query is then processed by the search server, step 170. Finally, in step 180, the results are returned to the searcher.

Server Token Architecture

To fully implement the token architecture there needs to be server side compliance to token utilization. Each catalog will have a defined schema/map, which may, for example, provide Bib-1 mapping to the catalog being searched. In this case, the catalog itself does not need to be Bib-1 compliant. It simply needs to provide a map to Bib-1. This defined map will be accessible by the server side token component architecture.

Referring back to FIG. 1, the server token architecture 33 of the token components provides communication with the client side that is transparent to the searcher. This is the central piece of the token logic. It allows for querying of any resource, independent of language, thereby providing true interoperability.

The server token architecture 33 is implemented using a server mapping builder 35. The server mapping builder 35 is made of two main parts that allow for development of server side catalog reference maps. The first part is a mapping wizard 37. The mapping wizard 37 allows the server administrator to create and apply token maps to the server catalogs using a point and click interface. The second part is a test view 39, which allows a user to view how passed queries will be interpreted by the mapping component.

While the above-described token architecture has made specific references to a Bib-1 implementation, the principles of the present invention are equally applicable to any mapping schema. In other words, the private and e-commerce applications of the mapping rules and architecture is far reaching. Private and Business to Business Networks will also benefit from the rich information interchange where specific mappings by SIC or other industry or private maps can be configured.

Resource Classifier

The third main component of the computer network search system 10 is a resource classifier 40. Classification of resources in a catalog is currently performed by pre-sorting resources to provide a classified catalog, based on rules that are hard-coded by an administrator and are then presented in a search interface to the searcher. This is commonly referred to as a portal. The logic being followed by the industry precludes customization and applies tremendous processing challenges, which almost assures searchers to never obtain complete results or access to all information in a catalog.

However, the resource classifier 40 of the present search system 10 provides the ability to perform resource classification “on-the-fly”. This new process and technology allows for server side and client side components with two main goals:

1. Allow the user to create a custom portal and classification rules; and

2. Eliminate the need for a Catalog of Classified Resources on the server side.

Using the system and method of the present invention, as a searcher performs searches on a catalog, the searcher can determine what rules or queries will be used to prepare results that they require or desire. The searcher may also build his or her own portal or classification rules, which are always accessible to the user and modifiable by the same. These rules (or complex queries), also known as client side rules, are passed to the server and provide more complete and better-classified results than are available via prior art search technologies.

Saving queries is a key component of “on-the-fly” classification. The system 10 allows queries to be saved using a saving query interface 42, which provides a plurality of customized portals. For example, if one searches for Automobiles in a catalog they may use the following query:

Select all where Subject=“Automobiles”.

If we save this query then we have a new category in the portal (resource classifier) called automobiles. Now, if we want to improve the search and search for only selected models of automobiles, the following queries could be utilized:

Select all where Subject=“Automobiles” and Model=“Ford”;

Select all where Subject=“Automobiles” and Model=“Chevy”;

Select all where Subject=“Automobiles” and Model=“Chrysler”;

Select all where Subject=“Automobiles” and Model=“BMW”. Now we can have a portal that has classification on the fly for all models listed above.

This even works in blended catalogs, where classification-on-the-fly is even more important. A blended catalog is one which has metadata embedded or structured resources as well as resources built via a full text search.

The classification on-the-fly structure is more than saved queries; it represents a builder and a resource distribution system that allows for collaboration of results and portals. In addition, its server side and client side structures allow for global interoperability.

Relevancy Processor

The fourth main component of the system of the system 10 of the present invention is a relevancy processor 50. The relevancy processor 50 includes a post catalog processing interface 52 and a relevancy builder 54. The relevancy processor solves the problems associated with searches that retrieve search results from fielded and non-fielded (full-text) resources or catalogs. Historically, it has been very difficult to blend results from these different types of resources and provide meaningful search result rankings. However, the relevancy processor 50 significantly changes this paradigm.

First, using the post catalog processing interface 52 a searcher and/or administrator can control the relevancy of search results. The post catalog processing interface 52 is a fully configurable graphical user interface. On the client side, a searcher can readily configure or determine those data elements that they desire to prioritize via a search form. For example, if results come from a catalog that supports fielded indexing, then those results can be given priority over results returned from non-fielded resources.

The following rules provide examples of how a searcher can control the relevancy of search results.

1. User can customize all public relevancy points;

2. User can save as defaults or select a relevancy for a particular search;

3. User can produce a mixed batch of results where a result set is produced for all relevancy rules.

On the server side, an administrator will also be able to configure what data elements they want to prioritize for the searcher. For example, if results come from a catalog that supports fielded indexing, then results retrieved from such a catalog can be given priority over results that come from a non-fielded catalog.

The following rules provide examples of how an administrator can control the relevancy of search results.

1. An administrator can define public and private relevancy points.

2. Administrator can set publicly available relevancy defaults, which will be accessible to all searchers.

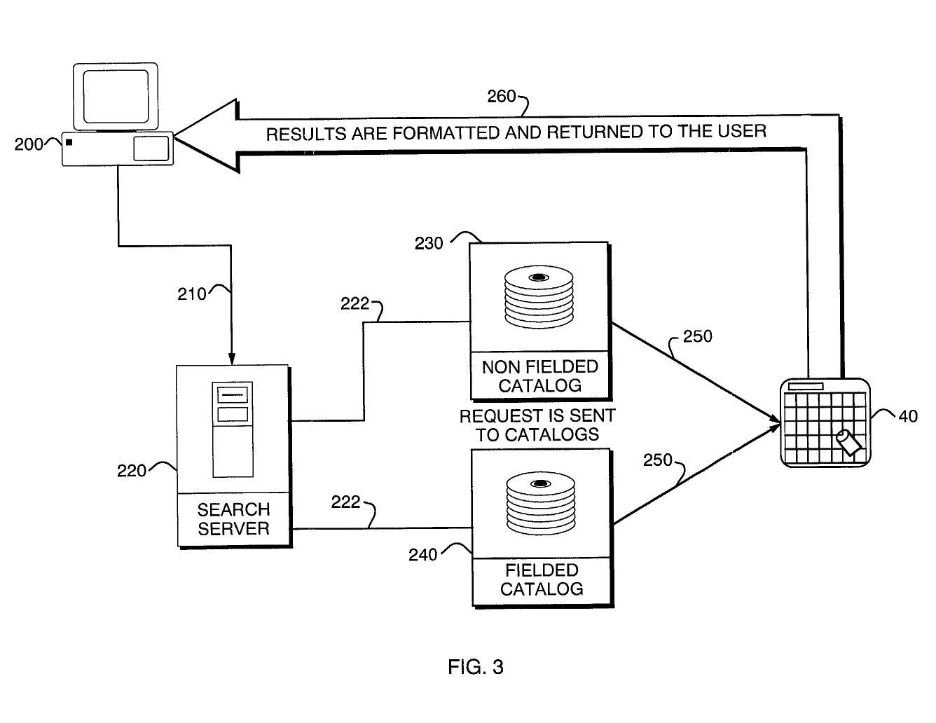

FIG. 3 provides a block diagram of how the system and method of the present invention allows blended searching of fielded and non-fielded catalogs using on-the-fly resource classification. First, a user prepares a search query using his or her computer 200. The query is then sent to a search server 220 over a communications link 210, which may be, for example, a large scale computer network, such as the Internet. The search server 220 then processes the query and sends a search request 222 to one or more non-fielded and fielded catalogs, 230 and 240, respectively. Search results 250 are returned from the catalogs and are provided to the relevancy processor 50 (FIG. 2) of the system of the present invention. The relevancy processor sets initial result values based on query rules, parses the results according to the rules and returns formatted results 260 to the searcher computer 200.

In summary, the relevancy processor allows for total control on how results are viewed in importance. Based on a Architecture made public by the administrator of the catalog server users can customize relevancy to suit their particular needs or to simply accept server configured defaults.

Modifications and substitutions by one ordinary skill in the art are considered to be within the scope of the present invention.

What is claimed is:

1. A computer network search system comprising:
a search interface builder allowing a system user to build at least one search interface;
a token implementer providing a client token architecture and a server token architecture;
a resource classifier providing on-the-fly resource classification; and
a relevancy processor.

2. The computer network search system of claim 1, wherein said search interface builder comprises a wizard-based drag-and-drop user interface including a set of tools.

3. The computer network search system of claim 2, wherein said set of tools comprises a component palette for providing access to additional system and third party components.

4. The computer network search system of claim 2, wherein said set of tools comprises a property inspector for providing a technical view of system components.

5. The computer network search system of claim 2, wherein said set of tools comprises a search form for providing a visual representation of a search strategy.

6. The computer network search system of claim 2, wherein said set of tools comprises an HTML/source view tab for providing access to source code that generates an HTML page.

7. The computer network search system of claim 2, wherein said set of tools comprises a preview tab for providing a page view of information.

8. The computer network search system of claim 2, wherein said set of tools comprises a test view part for providing a connection to a search/catalog server.

9. The computer network search system of claim 1, wherein said token implementer comprises a token parser for identifying document types.

10. The computer network search system of claim 1, wherein said client token architecture comprises a client side token map.

11. The computer network search system of claim 1, wherein said server token architecture comprises a server side token map.

12. The computer network search system of claim 11, wherein said server token architecture further comprises a server mapping builder including a mapping wizard to create and apply token maps and a test view to view how passed queries will be interpreted by the server token architecture.

13. The computer network search system of claim 1, wherein said resource classifier comprises a saving query interface to save queries as customized portals.

14. The computer network search system of claim 1, wherein said relevancy processor comprises a post catalog processing interface and a relevancy builder to blend search results returned from fielded and non-fielded resources.
